(19) United States
(12) Patent Application Publication
(10) Pub. No.: US 2024/0289695 A1
(43) Pub. Date: Aug. 29, 2024

(54) TRAINED MODEL GENERATION METHOD, INFERENCE APPARATUS, AND TRAINED MODEL GENERATION APPARATUS

(71) Applicant: KYOCERA Corporation, Kyoto-shi, Kyoto (JP)

(72) Inventors: Minami ASATANI, Asaka-shi, Saitama (JP); Kazuhisa ARAKAWA, Yokohama-shi, Kanagawa (JP)

(21) Appl. No.: 18/692,761

(22) PCT Filed: Sep. 15, 2022
(86) PCT No.: PCT/JP2022/034632

§ 371 Date: Mar. 15, 2024

(30) Foreign Application Priority Data
Sep. 17, 2021 (JP) 2021-152586

(51) Int. Cl. G06N 20/00

(52) U.S. Cl. CPC G06N 20/00

(57) ABSTRACT

A trained model generation method includes generating a trained model that outputs a recognition result of a recognition target included in input information, based on multiple models each including at least one of a first portion or a second portion. In the generating of the trained model, multiple base models each including a portion corresponding to the first portion are acquired, the multiple base models being trained based on at least one set of first information related to the input information. In the generating of the trained model, multiple target models each including a portion corresponding to the second portion are acquired, each of the multiple target models being trained based on at least one set of second information related to the input information with being connected to a respective base model of the multiple base models. In the generating of the trained model, the trained model at least including, among the multiple target models, a target model including the portion corresponding to the second portion is generated.

### CROSS-REFERENCE TO RELATED APPLICATIONS

This application claims priority from Japanese Patent Application No. 2021-152586 (filed in Japan on Sep. 17, 2021), the entire disclosure of which is incorporated herein by reference.

### TECHNICAL FIELD

The present disclosure relates to a trained model generation method, an inference apparatus, and a trained model generation apparatus.

### BACKGROUND OF INVENTION

In the related art, a system that causes a robot to take out a target object using a trained model is known (see, for example, Patent Literature 1).

### CITATION LIST

### Patent Literature

Patent Literature 1: Japanese Unexamined Patent Application Publication No. 2021-13996

### SUMMARY

In one embodiment of the present disclosure, a trained model generation method includes generating a trained model that outputs a recognition result of a recognition target included in input information, based on multiple models each including at least one of a first portion or a second portion. In the generating of the trained model, multiple base models each including a portion corresponding to the first portion are acquired, the multiple base models being trained based on at least one set of first information related to the input information. In the generating of the trained model, multiple target models each including a portion corresponding to the second portion are acquired, each of the multiple target models being trained based on at least one set of second information related to the input information with being connected to a respective base model of the multiple base models. In the generating of the trained model, the trained model at least including, among the multiple target models, a target model including the portion corresponding to the second portion is generated.

In one embodiment of the present disclosure, an inference apparatus includes a trained model generated based on multiple models each including at least one of a first portion or a second portion, the trained model being configured to output a recognition result of a recognition target included in input information. The trained model at least includes target models each including a portion corresponding to the second portion. The target models each including the portion corresponding to the second portion is a model obtained by performing training based on at least one set of second information related to the input information with being connected to a respective base model of multiple base models each including a portion corresponding to the first portion. The multiple base models each including the portion corresponding to the first portion is a model trained based on at least one set of first information related to the input information.

In one embodiment of the present disclosure, a trained model generation apparatus includes a controller configured to generate a trained model that outputs a recognition result of a recognition target included in input information, based on multiple models each including at least one of a first portion or a second portion. In the generating of the trained model, the controller acquires multiple base models each including a portion corresponding to the first portion, the multiple base models being trained based on at least one set of first information related to the input information. The controller acquires multiple target models each including a portion corresponding to the second portion, each of the multiple target models being trained based on at least one set of second information related to the input information with being connected to a respective base model of the multiple base models. The controller generates the trained model at least including, among the multiple target models, a target model including the portion corresponding to the second portion.

### BRIEF DESCRIPTION OF THE DRAWINGS

FIG. 1 is a block diagram illustrating a configuration example of a trained model generation system according to one embodiment.

FIG. 2 is a diagram illustrating a configuration example of a trained model.

FIG. 3 is a schematic diagram illustrating an example of an operation of generating multiple preliminary models having different backbones by training.

FIG. 4 is a schematic diagram illustrating an example of an operation of generating a head by training using the backbones of the preliminary models.

FIG. 5 is a schematic diagram illustrating an example of an operation of generating multiple preliminary models having different heads by training.

FIG. 6 is a schematic diagram illustrating an example of an operation of generating a backbone by training using the heads of the preliminary models.

FIG. 7 is a schematic diagram illustrating generation of the preliminary models and generation of the head together.

FIG. 8 is a schematic diagram illustrating generation of the preliminary models and generation of the backbone together.

FIG. 9 is a flowchart illustrating an example of a procedure of a trained model generation method.

FIG. 10 is a schematic diagram illustrating a configuration example of a robot control system.

FIG. 11 is a diagram illustrating a configuration example in which the trained model includes a branch model.

FIG. 12 is a diagram illustrating a configuration example of a model in which a first portion is connected between two divided second portions.

### DESCRIPTION OF EMBODIMENTS

### (Configuration Example of Trained Model Generation System 1)

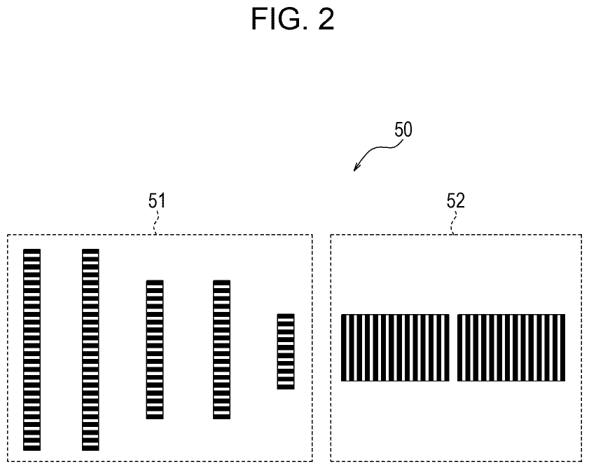

A trained model generation system 1 according to one embodiment of the present disclosure generates a trained model 50 (see FIG. 2 and the like) that outputs a recognition result of a recognition target included in input information. The trained model generation system 1 generates multiple preliminary models as preparation for generating the trained model 50, trains a model to which a portion of each of the preliminary models is connected to update the model, and thus generates the trained model 50. The trained model generation system 1 trains a model to which the multiple preliminary models are connected, and thus can increase the inference accuracy of the trained model 50. The trained model generation system 1 generates the trained model 50 using portions of the preliminary models, and thus can reduce a work load for generating the trained model 50. In this specification, the preliminary models are also referred to as base models. A model generated by training a model to which a preliminary model is connected is also referred to as a target model.

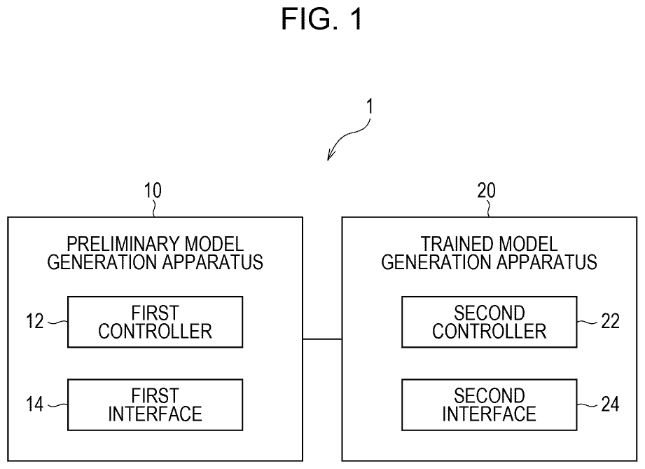

As illustrated in FIG. 1, the trained model generation system 1 according to the one embodiment of the present disclosure includes a preliminary model generation apparatus 10 and a trained model generation apparatus 20. In the trained model generation system 1, the preliminary model generation apparatus 10 generates the preliminary models, and the trained model generation apparatus 20 generates the trained model 50. The preliminary model generation apparatus 10 and the trained model generation apparatus 20 may be separate apparatuses or may be an integrated apparatus.

The preliminary model generation apparatus 10 includes a first controller 12 and a first interface 14. The trained model generation apparatus 20 includes a second controller 22 and a second interface 24. The terms “first” and “second” are merely given to distinguish the components included in the different apparatuses from each other. The first controller 12 and the second controller 22 are also referred to simply as controllers. The first interface 14 and the second interface 24 are also referred to simply as interfaces.

### <Controllers>

To provide control and processing capabilities for performing various functions, the controllers may each include at least one processor. The processor may execute a program for implementing the various functions of the controller. The processor may be implemented as a single integrated circuit. The integrated circuit is also referred to as an IC. The processor may be implemented as multiple integrated circuits and discrete circuits connected to be able to perform communication. The processor may be implemented based on various other known technologies.

The controllers may each include a storage. The storage may include an electromagnetic storage medium such as a magnetic disk, or may include a memory such as a semiconductor memory or a magnetic memory. The storage stores various kinds of information. The storage stores a program or the like to be executed by the controller. The storage may be a non-transitory readable medium. The storage may function as a work memory of the controller. At least a part of the storage may be a separate device from the controller.

### <Interfaces>

The first interface 14 of the preliminary model generation apparatus 10 and the second interface 24 of the trained model generation apparatus 20 input and output information or data to and from each other. The first interface 14 outputs information or data acquired from the first controller 12 to the trained model generation apparatus 20, and outputs information or data acquired from the trained model generation apparatus 20 to the first controller 12. The second interface 24 outputs information or data acquired from the preliminary model generation apparatus 10 to the second controller 22. The interfaces may each include a communication device that can perform wired or wireless communication. The interfaces are also referred to as communication units. The communication device can perform communication in accordance with communication schemes based on various communication standards. The interfaces can be based on a known communication technology.

### (Configuration Example of Trained Model 50)

As illustrated in FIG. 2, the trained model 50 is represented as a model in which a first trained model 51 and a second trained model 52 are connected to each other. The first trained model 51 is also referred to as a backbone. The second trained model 52 is also referred to as a head. The backbone outputs an extraction result of a feature quantity of input information. The feature quantity represents, for example, a feature of the appearance, such as an edge or a pattern, of a learning target as a numerical value. The backbone may include, for example, convolution layer and pooling layer. The head performs a predetermined determination for the input information, based on the output of the backbone. Specifically, the head may output a recognition result of a recognition target included in the input information, based on the extraction result of the feature quantity of the input information output by the backbone. The head may include a fully-connected layer that processes the extraction result of the feature quantity obtained by the backbone. Note that the head may include convolution layer and pooling layer. The head performs recognition of a recognition target, as the predetermined determination. For example, in a task of distinguishing between a horse and a zebra from each other, the feature quantity may be a parameter representing the proportion of the striped pattern area to the body surface. The predetermined determination can be determining whether the recognition target is a horse or a zebra by comparing the proportion of the striped pattern area to the body surface with a threshold. For example, in a task of distinguishing between an abalone (awabi in Japanese) and a small abalone (tokobushi in Japanese), the feature quantity may be a parameter representing the size or the number of holes in the shell. The predetermined determination may be determining whether the recognition target is an abalone or a small abalone by comparing the size or the number of holes in the shell with a threshold.

The trained model 50 may include a convolution neural network (CNN) having multiple layers. In each of the layers of the CNN, convolution based on a predetermined weighting coefficient is performed on the information input to the trained model 50. In training for the trained model 50, the weighting coefficient is updated. The trained model 50 may include a fully-connected layer. The trained model 50 may be VGG16 or ResNet50. The trained model 50 may be a transformer. The trained model 50 is not limited to these examples, and may be various other models.

### (Operation Example of Trained Model Generation System 1)

In the trained model generation system 1, the trained model generation apparatus 20 generates or acquires in advance multiple preliminary models each including a backbone and a head. To generate the head portion of the trained model 50, the trained model generation apparatus 20 prepares one head for training. The trained model generation apparatus 20 sequentially connects the backbone of each of the multiple preliminary models to the one head for training. The trained model generation apparatus 20 trains a model in which the backbone of each of the preliminary models is connected to the head for training to update the head for training. The trained model generation apparatus 20 sequentially connects the backbone of each of the preliminary models to the head for training, performs training, and updates the head for training. The trained model generation apparatus 20 uses, as the head of the trained model 50, the trained head obtained upon the completion of training of the model to which the backbone of each of the preliminary models is connected. The trained model generation apparatus 20 separately generates or acquires the backbone of the trained model 50. The trained model generation apparatus 20 connects the trained head to the separately generated or acquired backbone to generate the trained model 50.

The trained model generation apparatus 20 may train a model to which the head portion of each of the preliminary models is sequentially connected to generate the backbone portion of the trained model 50. For both the backbone portion and the head portion of the trained model 50, the trained model generation apparatus 20 may sequentially connect the preliminary models to a model for training, perform training, and thus generate the trained model 50.

That is, the trained model generation apparatus 20 updates a yet-to-be-trained model by training, and thus generates the trained model 50. The yet-to-be-trained model is a model in which a first yet-to-be-trained model corresponding to a first trained preliminary model 41 and a second yet-to-be-trained model corresponding to a second trained preliminary model 42 are connected to each other. The trained model generation apparatus 20 may train a model in which the first trained preliminary model 41, instead of the first yet-to-be-trained model, is connected to the second yet-to-be-trained model to update the second yet-to-be-trained model, and thus generate the second trained model 52. The trained model generation apparatus 20 may train a model in which the second trained preliminary model 42, instead of the second yet-to-be-trained model, is connected to the first yet-to-be-trained model to update the first yet-to-be-trained model, and thus generate the first trained model 51.

In the present embodiment, a model has at least one of a first portion or a second portion. That is, the base model has at least one of the first portion or the second portion. The first yet-to-be-trained model of the yet-to-be-trained model corresponds to the first portion of the model. The second yet-to-be-trained model of the yet-to-be-trained model corresponds to the second portion of the model. The first trained model 51 of the trained model 50 corresponds to the first portion of the model. The second trained model 52 of the trained model 50 corresponds to the second portion of the model.

<Generation of Head based on Training of Models to which Multiple Backbones Are Connected>

Description is given below of an operation example in which the trained model generation system 1 trains a model in which the backbone of each of the preliminary models is connected to the head for training and thus generates the head of the trained model 50.

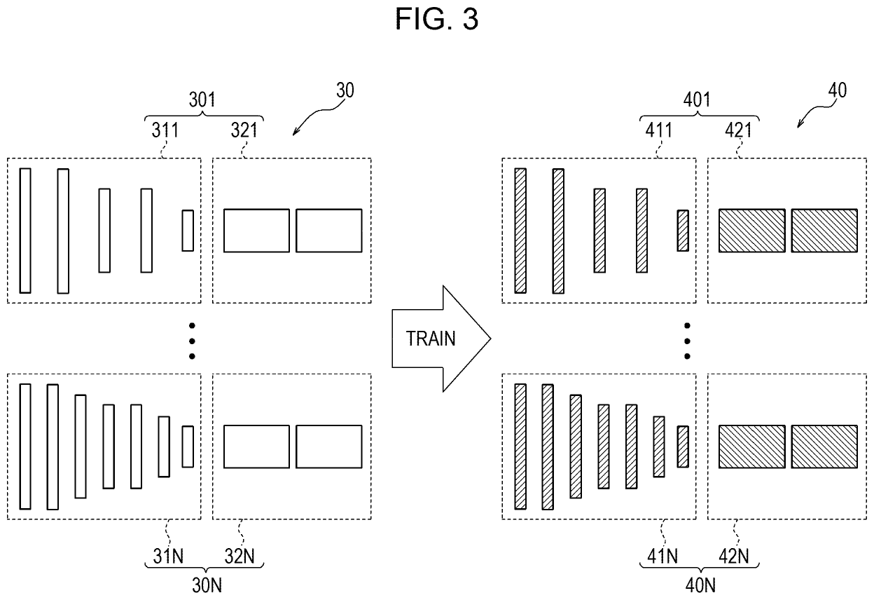

As illustrated in FIG. 3, the first controller 12 of the preliminary model generation apparatus 10 generates or acquires multiple yet-to-be-trained preliminary models 301 to 30N in advance. The yet-to-be-trained preliminary models 301 to 30N are also collectively referred to as yet-to-be-trained preliminary models 30.

The yet-to-be-trained preliminary model 301 includes a first yet-to-be-trained preliminary model 311 and a second yet-to-be-trained preliminary model 321. The yet-to-be-trained preliminary model 30N includes a first yet-to-be-trained preliminary model 31N and a second yet-to-be-trained preliminary model 32N. The first yet-to-be-trained preliminary models 311 to 31N of the yet-to-be-trained preliminary models 30 correspond to the first portion of the model. The second yet-to-be-trained preliminary models 321 to 32N of the yet-to-be-trained preliminary models 30 correspond to the second portion of the model. In FIG. 3, the layer configuration of the CNN or the filter size of each layer in the first yet-to-be-trained preliminary model 311 is different from the layer configuration of the CNN or the filter size of each layer in the first yet-to-be-trained preliminary model 31N. That is, the layer configurations of the CNNs or the filter sizes of the respective layers in the first yet-to-be-trained preliminary models 311 to 31N are different from each other. The filter size refers to the size of a filter used to perform convolution (down-sampling) or transposed convolution (up-sampling) in the CNN. The model configurations of the first yet-to-be-trained preliminary models 311 to 31N may be different from or identical to each other. In FIG. 3, the layer configuration of the fully-connected layer or the parameter size of each layer in the second yet-to-be-trained preliminary model 321 is identical to the layer configuration of the fully-connected layer or the parameter size of each layer in the second yet-to-be-trained preliminary model 32N. That is, the layer configurations of the fully-connected layers or the parameter sizes of the respective layers in the second yet-to-be-trained preliminary models 321 to 32N are identical. The layer configurations of the fully-connected layers or the parameter sizes of the respective layers in the second yet-to-be-trained preliminary models 321 to 32N may be different from each other. The parameter size refers to the number of units of a fully-connected layer, or the like. The model configurations of the second yet-to-be-trained preliminary models 321 to 32N may be different from or identical to each other.

The first controller 12 trains each yet-to-be-trained preliminary model 30 using, as training data, first information identical to or related to input information to be input to the trained model 50. The first information may include multiple training images as one set. The first controller 12 may train the yet-to-be-trained preliminary models 30 using, as training data, the identical set of the first information or may train the yet-to-be-trained preliminary models 30 using, as training data, different sets of the first information. That is, the first controller 12 may train the yet-to-be-trained preliminary models 30 based on at least one set of the first information. The first controller 12 updates the yet-to-be-trained preliminary models 30 by training and generates multiple trained preliminary models 401 to 40N. The trained preliminary models 401 to 40N are also collectively referred to as trained preliminary models 40. The training data may include labeled training data used in so-called supervised learning. The training data may include data that is used in so-called unsupervised learning and is generated by an apparatus that performs training.

The trained preliminary model 401 includes a first trained preliminary model 411 and a second trained preliminary model 421. The trained preliminary model 40N includes a first trained preliminary model 41N and a second trained preliminary model 42N. The first trained preliminary models 411 to 41N of the trained preliminary models 40 correspond to the first portion of the base model. The second trained preliminary models 421 to 42N of the trained preliminary models 40 correspond to the second portion of the base model. The layer configurations of the CNNs or the filter sizes of layers in the first trained preliminary models 411 to 41N are identical to the layer configurations of the CNNs or the filter sizes of the layers in the first yet-to-be-trained preliminary models 311 to 31N, respectively. The layer configurations of the fully-connected layers or the parameter sizes of layers in the second trained preliminary models 421 to 42N are identical to the layer configurations of the fully-connected layers or the parameter sizes of layers in the second yet-to-be-trained preliminary models 321 to 32N, respectively.

The second controller 22 of the trained model generation apparatus 20 acquires the trained preliminary models 40 as preliminary models from the preliminary model generation apparatus 10. The preliminary model generation apparatus 10 may output the trained preliminary models 40 to the trained model generation apparatus 20 via the first interface 14. The trained model generation apparatus 20 may acquire the trained preliminary models 40 from the preliminary model generation apparatus 10 via the second interface 24.

The second controller 22 trains a model in which the backbone of each preliminary model is connected to the head for training using, as training data, second information identical to or related to input information to be input to the trained model 50. The backbone of each preliminary model corresponds to the first portion of the base model. The head for training corresponds to the second portion of the target model. The second information may be identical to or different from the first information. The second information may include multiple training images as one set. The second controller 22 may train models in which the backbone of the respective preliminary models is connected to the head for training using, as training data, the identical set of the second information or may train the models using, as training data, different sets of the second information. The second controller 22 may divide one set of the second information into smaller subsets, and perform training using a different subset as the training data each time the backbone connected to the head for training is changed. The second controller 22 may perform training using the identical subset as the training data when the backbone connected to the head for training is changed. That is, the second controller 22 may train a model in which the backbone of each preliminary model is connected to the head for training, based on at least one set of the second information. Note that an information amount of the second information used in training for the trained model 50 may be equal to or less than an information amount of the first information used for training of the preliminary models. Note that the information amount refers to, for example, the number of training images included in the second information.

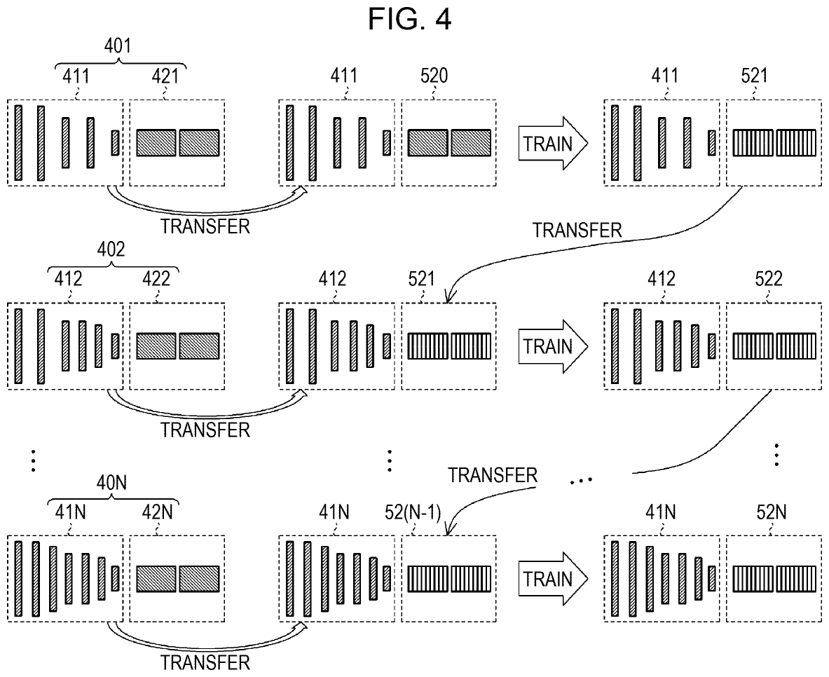

Specifically, as illustrated in FIG. 4, the second controller 22 sequentially train a model in which the backbone (the first trained preliminary models 411 to 41N) of each of the preliminary models is transferred and connected to a second yet-to-be-trained model 520 or a respective one of second training-underway models 521 to 52(N−1). The second controller 22 may perform training in a procedure below. The second controller 22 trains a model in which the first trained preliminary model 411 is connected to the second yet-to-be-trained model 520 to update the second yet-to-be-trained model 520 to the second training-underway model 521. The second controller 22 trains a model in which the first trained preliminary model 412 is connected to the second training-underway model 521, which is obtained by the update in the previous step, to update the second training-underway model 521 to the second training-underway model 522. The second controller 22 trains a model in which the first trained preliminary model 41N is connected to the second training-underway model 52(N−1), which is obtained by the update in the previous step, to update the second training-underway model 52(N−1) to a second trained model 52N.

The second controller 22 executes the procedure described above to generate the second trained model 52N. The second controller 22 employs the second trained model 52N as the second trained model 52 (the head of the trained model 50). The second trained model 52N generated by training with being connected to the first portion of the base model corresponds to the second portion of the target model.

<Generation of Backbone based on Training of Models to which Multiple Heads Are Connected>

Description is given below of an operation example in which the trained model generation system 1 trains a model in which the head of each of the preliminary model is connected to the backbone for training and thus generates the backbone of the trained model 50.

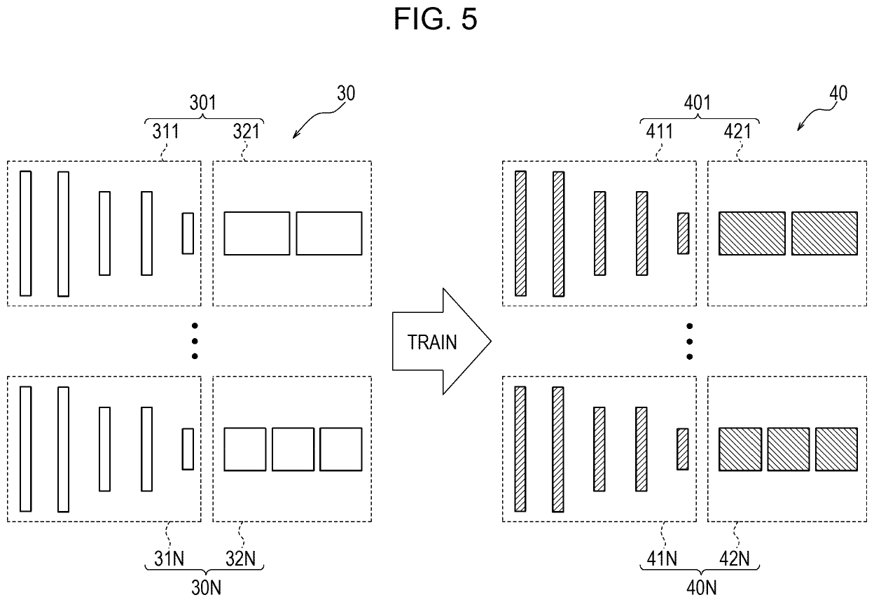

As illustrated in FIG. 5, the first controller 12 of the preliminary model generation apparatus 10 generates or acquires the multiple yet-to-be-trained preliminary models 301 to 30N in advance. In FIG. 5, the layer configuration of the fully-connected layer or the parameter size of each layer in the second yet-to-be-trained preliminary model 321 and the layer configuration of the fully-connected layer or the parameter size of each layer in the second yet-to-be-trained preliminary model 32N are different from each other. That is, the layer configurations of the fully-connected layers or the parameter sizes of the respective layers in the second yet-to-be-trained preliminary models 321 to 32N are different from each other. In FIG. 5, the layer configuration of the CNN or the filter size of each layer in the first yet-to-be-trained preliminary model 311 is identical to the layer configuration of the CNN or the filter size of each layer in the first yet-to-be-trained preliminary model 31N. That is, the layer configurations of the CNNs or the filter sizes of the respective layers in the first yet-to-be-trained preliminary models 311 to 31N are identical. The layer configurations of the CNNs or the filter sizes of the respective layers in the first yet-to-be-trained preliminary models 311 to 31N may be different from each other.

The first controller 12 trains each yet-to-be-trained preliminary model 30 using, as training data, the first information identical to or related to input information to be input to the trained model 50. The first controller 12 updates the yet-to-be-trained preliminary models 30 by training and generates the multiple trained preliminary models 401 to 40N. The layer configurations of the fully-connected layers or CNNs or the parameter sizes or filter sizes of layers in the trained preliminary models 40 are identical to the layer configurations of the fully-connected layers or CNNs or the parameter sizes or filter sizes of layers in the respective yet-to-be-trained preliminary models 30.

The second controller 22 of the trained model generation apparatus 20 acquires the trained preliminary models 40 as preliminary models from the preliminary model generation apparatus 10. The second controller 22 trains a model in which the head of each preliminary model is connected to the backbone for training using, as training data, third information identical to or related to input information to be input to the trained model 50. The head of each preliminary model corresponds to the second portion of the base model. The backbone for training corresponds to the first portion of the target model. The third information may be identical to or different from the first information or the second information. The third information may include multiple training images as one set. The second controller 22 may train models in which the head of the respective preliminary models is connected to the backbone for training using, as training data, the identical set of the third information or may train the models using, as training data, different sets of the third information. The second controller 22 may divide one set of the third information into smaller subsets, and perform training using a different subset as the training data each time the head connected to the backbone for training is changed. The second controller 22 may perform training using, as the training data, the identical subset when the head connected to the backbone for training is changed. That is, the second controller 22 may train a model in which the head of each preliminary model is connected to the backbone for training, based on at least one set of the third information. Note that an information amount of the third information used in training for the trained model 50 may be equal to or less than an information amount of the first information used for training of the preliminary models. Note that the information amount refers to, for example, the number of training images included in the third information.

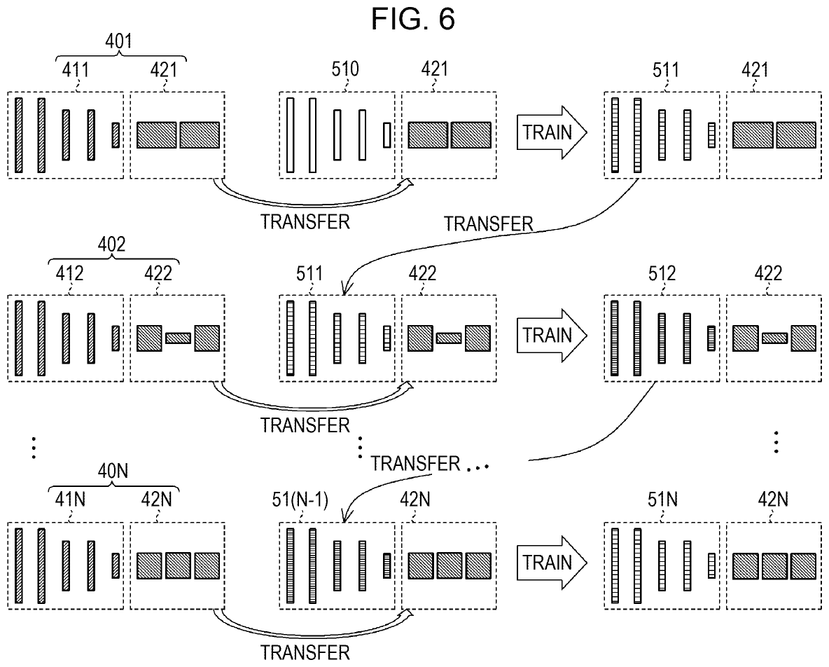

Specifically, as illustrated in FIG. 6, the second controller 22 sequentially train a model in which the head (the second trained preliminary models 421 to 42N) of each of the preliminary models is transferred and connected to a first yet-to-be-trained model 510 or a respective one of first training-underway models 511 to 51(N−1). The second controller 22 may perform training in a procedure below. The second controller 22 trains a model in which the second trained preliminary model 421 is connected to the first yet-to-be-trained model 510 to update the first yet-to-be-trained model 510 to the first training-underway model 511. The second controller 22 trains a model in which the second trained preliminary model 422 is connected to the first training-underway model 511, which is obtained by the update in the previous step, to update the first training-underway model 511 to the first training-underway model 512. The second controller 22 trains a model in which the second trained preliminary model 42N is connected to the first training-underway model 51(N−1), which is obtained by the update in the previous step, to update the first training-underway model 51(N−1) to a first trained model 51N.

The second controller 22 executes the procedure described above to generate the first trained model 51N. The second controller 22 employs the first trained model 51N as the first trained model 51 (the backbone of the trained model 50). The first trained model 51N generated by training with being connected to the second portion of the base model corresponds to the first portion of the target model.

### <Generation of Trained Model 50>

The second controller 22 of the trained model generation apparatus 20 connects the first trained model 51 and the second trained model 52 to each other to generate the trained model 50.

If the second controller 22 has generated the second trained model 52 (head) based on the preliminary models, the second controller 22 connects the first trained model 51 (backbone) to the generated second trained model 52 to generate the trained model 50. The second controller 22 may generate the first trained model 51 by another means or may acquire the first trained model 51 from another apparatus. The second controller 22 may acquire, as the first trained model 51, at least one of the multiple first trained preliminary models 41.

If the second controller 22 has generated the first trained model 51 (backbone) based on the preliminary models, the second controller 22 connects the second trained model 52 (head) to the generated first trained model 51 to generate the trained model 50. The second controller 22 may generate the second trained model 52 by another means or may acquire the second trained model 52 from another apparatus. The second controller 22 may acquire, as the second trained model 52, at least one of the multiple second trained preliminary models 42.

The second controller 22 may generate both the first trained model 51 (backbone) and the second trained model 52 (head) based on the preliminary models. The second controller 22 connects the first trained model 51 and the second trained model 52 that are generated based on the preliminary models to generate the trained model 50.

The second controller 22 may generate the trained model 50 that includes the second trained model 52 alone that is generated by training with being connected to the first trained preliminary models 41. The second controller 22 may generate the trained model 50 that includes the first trained model 51 alone that is generated by training with being connected to the second trained preliminary models 42.

### BRIEF SUMMARY

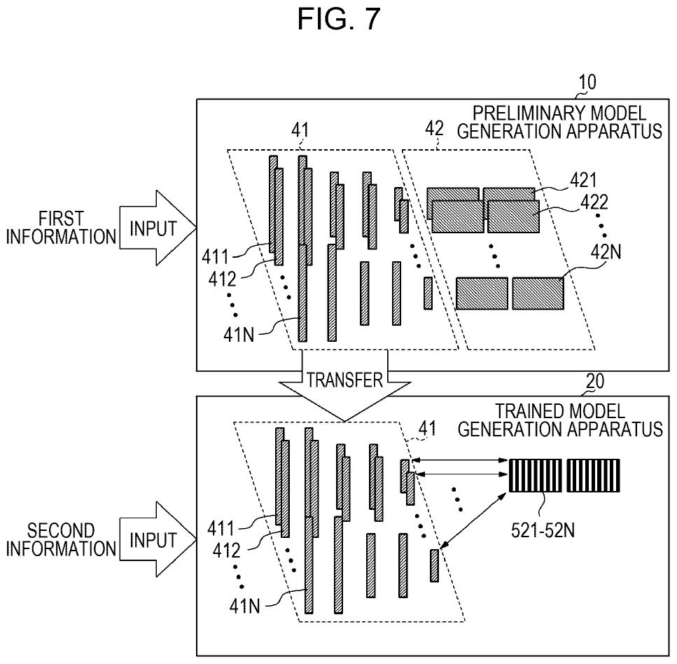

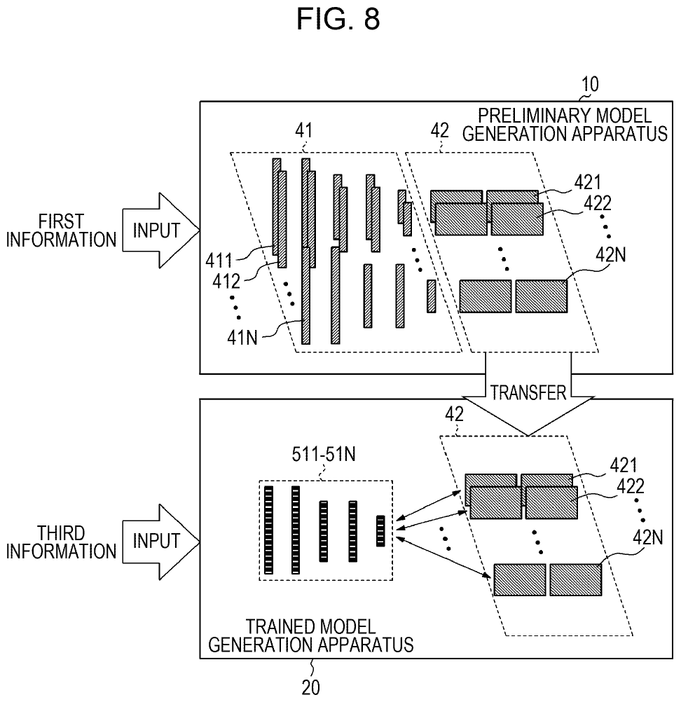

In the trained model generation system 1, the preliminary model generation apparatus 10 generates preliminary models, and the trained model generation apparatus 20 generates the trained model 50 based on the preliminary models. In the trained model generation system 1, as illustrated in FIGS. 7 and 8, the preliminary model generation apparatus 10 performs training by using the first information as the training data and thus generates the trained preliminary models 40 including the first trained preliminary models 41 and the second trained preliminary models 42.

As illustrated in FIG. 7, the trained model generation system 1 may transfer the first trained preliminary models 41 to the trained model generation apparatus 20. The trained model generation apparatus 20 may train models in which the first trained preliminary models 411 to 41N are respectively connected to the second yet-to-be-trained model 520 and the second training-underway models 521 to 52(N−1), by using the second information as the training data, and may thus generate the second training-underway models 521 to 52(N−1) and the second trained model 52N, respectively.

As illustrated in FIG. 8, the trained model generation system 1 may transfer the second trained preliminary models 42 to the trained model generation apparatus 20. The trained model generation apparatus 20 may train models in which the second trained preliminary models 421 to 42N are respectively connected to the first yet-to-be-trained model 510 and the first training-underway models 511 to 51(N−1), by using the third information as the training data, and may thus generate the first training-underway models 511 to 51(N−1) and the first trained model 51N, respectively.

The trained model generation apparatus 20 may employ the generated second trained model 52N as the second trained model 52. The trained model generation apparatus 20 may employ any of the second training-underway models 521 to 52(N−1) as the second trained model 52. The trained model generation apparatus 20 may employ the generated first trained model 51N as the first trained model 51. The trained model generation apparatus 20 may employ any of the first training-underway models 511 to 51(N−1) as the first trained model 51.

The trained model generation apparatus 20 connects the first trained model 51 to the generated second trained model 52 to generate the trained model 50. The trained model generation apparatus 20 may select the first trained model 51 to be connected to the generated second trained model 52 from among the multiple first trained preliminary models 41. The trained model generation apparatus 20 may acquire the first trained model 51 to be connected to the generated second trained model 52 from an external apparatus. The trained model generation apparatus 20 connects the second trained model 52 to the generated first trained model 51 to generate the trained model 50. The trained model generation apparatus 20 may select the second trained model 52 to be connected to the generated first trained model 51 from among the multiple second trained preliminary models 42. The trained model generation apparatus 20 may acquire the second trained model 52 to be connected to the generated first trained model 51 from an external apparatus. The trained model generation apparatus 20 may connect the generated first trained model 51 and the generated second trained model 52 to each other to generate the trained model 50.

### <Example of Procedure of Method of Generating Trained Model 50>

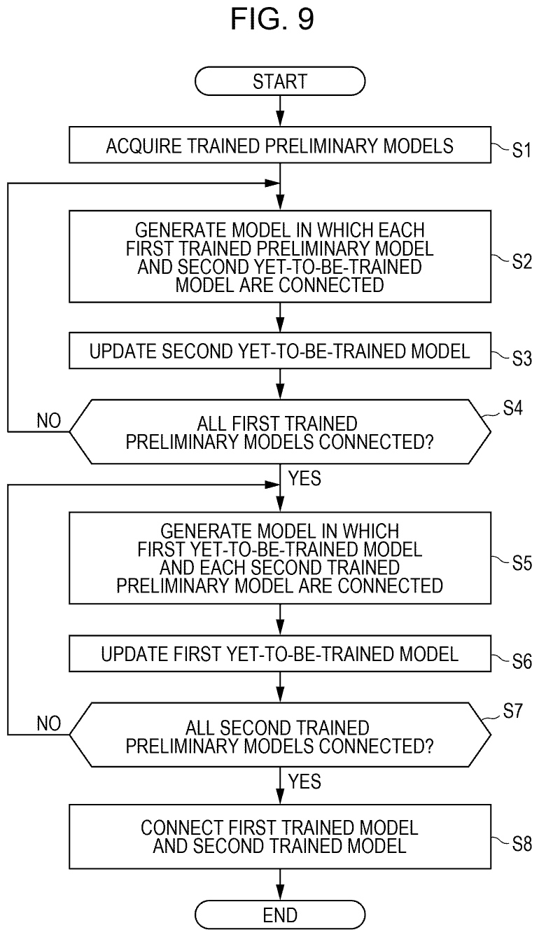

The trained model generation apparatus 20 may perform a method of generating the trained model 50 including a procedure of a flowchart illustrated in FIG. 9. The method of generating the trained model 50 may be implemented as a program of generating the trained model 50 to be executed by a processor included in the second controller 22 of the trained model generation apparatus 20. The program of generating the trained model 50 may be stored in a non-transitory computer readable medium.

The second controller 22 acquires the multiple trained preliminary models 40 from the preliminary model generation apparatus 10 (step S1). The second controller 22 generates a model in which the first trained preliminary model 41 of one of the trained preliminary models 40 and the second yet-to-be-trained model 520 are connected to each other (step S2). The second controller 22 updates the second yet-to-be-trained model 520 by training the model generated in step S2, and thus generates the second training-underway model 521 (step S3).

The second controller 22 determines whether all the first trained preliminary models 41 of the multiple trained preliminary models 40 have been connected (step S4). If all the first trained preliminary models 41 have not been connected (step S4: NO), the process returns to the procedure of step S2, in which the second controller 22 generates a model in which one of the first trained preliminary models 41 that are not connected yet is connected to a respective one of the second training-underway models 521 to 52(N−1). In addition, the second controller 22 updates the one of the second training-underway models 521 to 52(N−1) in the procedure of step S3, and generates a respective one of the second training-underway models 522 to 52(N−1) and the second trained model 52N.

If all the first trained preliminary models 41 have been connected (step S4: YES), the second controller 22 generates a model in which the second trained preliminary model 42 of one of the trained preliminary models 40 and the first yet-to-be-trained model 510 are connected to each other (step S5). The second controller 22 updates the first yet-to-be-trained model 510 by training the model generated in step S5, and thus generates the first training-underway model 511 (step S6).

The second controller 22 determines whether all the second trained preliminary models 42 of the multiple trained preliminary models 40 have been connected (step S7). If all the second trained preliminary models 42 have not been connected (step S7: NO), the process returns to the procedure of step S5, in which the second controller 22 generates a model in which one of the second trained preliminary models 42 that are not connected yet is connected to a respective one of the first training-underway models 511 to 51(N−1). The second controller 22 updates the one of the first training-underway models 511 to 51(N−1) in the procedure of step S6, and generates a respective one of the first training-underway models 512 to 51(N−1) or the first trained model 51N.

If all the second trained preliminary models 42 have been connected (step S7: YES), the second controller 22 connects the first trained model 51 and the second trained model 52 to each other to generate the trained model 50 (step S8). Specifically, the second controller 22 employs, as the first trained model 51, the first trained model 51N generated by the update performed in the procedure of steps S5 and S6. The second controller 22 employs, as the second trained model 52, the second trained model 52N generated by the update performed in the procedure of steps S2 and S3. After executing the procedure of step S8, the second controller 22 ends the execution of the procedure of the flowchart of FIG. 9. After executing the procedure of step S4, the second controller 22 may proceed to the procedure of step S8 without executing the procedure from step S5 to step S7. After executing the procedure of step S1, the second controller 22 may proceed to the procedure of step S5 without executing the procedure from step S2 to step S4.

As described above, the trained model generation apparatus 20 according to the present embodiment generate multiple preliminary models, and generate the trained model 50 using each of the preliminary models. The trained model generation apparatus 20 generates a model in which a portion of the multiple preliminary models is connected to a training-underway model corresponding to the first trained model 51 or the second trained model 52 which is a portion of the trained model 50. The trained model generation apparatus 20 trains the generated model to update the training-underway model, and thus generates the first trained model 51 or the second trained model 52. The trained model generation apparatus 20 generates the trained model 50 by using the generated first trained model 51 or the generated second trained model 52. As a result of training the model connected to the multiple preliminary models, the recognition accuracy for various recognition targets can be increased on average. Consequently, the recognition accuracy in recognition using the trained model 50 can be increased.

### (Meaning of Identical or Related Information)

The trained model generation system 1 according to the present embodiment uses, as the training data, information identical to or related to input information to be input to the trained model 50. The information identical to or related to the input information may be information of a task identical to or related to a task executed by the trained model 50 that receives the input information. For example, when the task is to classify mammals included in an image, an example of the input information is images of living things including mammals. The information related to the learning target generated as information of the task identical to the task for the input information is images of mammals. The information related to the learning target generated as the information of the task related to the input information is, for example, images of reptiles.

Examples of the task may include a classification task of classifying a recognition target included in the input information into at least two types. The classification task may be subdivided into, for example, a task of distinguishing whether the recognition target is a dog or a cat or a task of distinguishing whether the recognition target is a cow or a horse. The task is not limited to the classification task, and may include a task for implementing other various operations. The task may include segmentation for making determination from pixels that belong to a particular target object. The task may include object detection for detecting an enclosed rectangular region. The task may include pose estimation of a target object. The task may include keypoint detection to find certain feature points.

When both the input information and the information related to the learning target are information of the classification task, a relationship between the input information and the information related the learning target is the information of the related task. When both the input information and the information related to the learning target are information of the task of distinguishing whether the recognition target is a dog or a cat, a relationship between the input information and the information related to the learning target is information of the identical task. The relationship between the input information and the information related to the learning target is not limited to these examples, and may be determined based on various conditions.

### OTHER EMBODIMENTS

Other embodiments are described below.

(When Second Information or Third Information Is Made Different from First Information)

The second controller 22 of the trained model generation apparatus 20 may make the second information or the third information used as the training data in training different from the first information used as the training data in training for generating preliminary models. For example, when the first information that is the training data used in training for generating the preliminary models is information for recognizing industrial parts, the second controller 22 may use, as the second information or the third information, information for recognizing types of screws by specializing screws alone among the industrial parts. For example, when the first information that is the training data used in training for generating the preliminary models is information for recognizing animals, the second controller 22 may use, as the second information or the third information, information for recognizing kinds of dogs by specializing dogs alone among the animals. The trained model 50 that recognize a broader category such as industrial parts or animals is also referred to as a general-purpose model. The trained model 50 that recognizes a narrower category such as types of screws or kinds of dogs is also referred to as a dedicated model.

The second controller 22 may set a granularity of the second information or the third information to be smaller than a granularity of the first information. The granularity of information means the fineness of classification of the recognition target. For example, suppose that the trained model 50 recognizes industrial parts as the recognition target. The granularity of information for classifying industrial parts into screws, nuts, washers, brackets, or the like is larger than the granularity of information for classifying screws by length, diameter, or the like. In other words, the granularity of information changes depending on the large classification, the medium classification, or the small classification of the recognition target. As the granularity of the information used as the training data is smaller, the trained model 50 can recognize a finer difference in the recognition target. On the other hand, when the granularity of information used as the training data is too small, the trained model 50 may fail to recognize a large difference in the recognition target. For example, the trained model 50 that can recognize a difference between screws by length or diameter may fail to recognize a difference between screws and nuts. The trained model 50 generated by training using, as the training data, information having a large granularity corresponds to a general-purpose model. The trained model 50 generated by training using, as the training data, information having a small granularity corresponds to a dedicated model.

### (Evaluation and Regeneration of Trained Model 50)

The second controller 22 of the trained model generation apparatus 20 may evaluate the recognition accuracy with which the generated trained model 50 recognizes the recognition target. The second controller 22 may regenerate the trained model 50 based on the evaluation result of the recognition accuracy.

Specifically, the second controller 22 acquires the recognition result output from the generated trained model 50 in response to the input information being input to the trained model 50. The second controller 22 may input information for which a correct recognition result is known, to the trained model 50 as the input information, and evaluate the rate at which the obtained recognition result matches the correct recognition result (correct answer rate). The second controller 22 may calculate a correct answer rate as an evaluation value. In this case, the higher the evaluation value, the higher the recognition accuracy of the trained model 50. If the evaluation value is equal to or greater than a predetermined threshold, the second controller 22 may determine that the recognition accuracy of the generated trained model 50 is sufficient. If the evaluation value is less than the predetermined threshold, the second controller 22 may determine that the recognition accuracy of the generated trained model 50 is insufficient.

When the recognition accuracy of the trained model 50 is insufficient, the trained model generation system 1 may regenerate the trained model 50. When the trained model 50 is regenerated, the second controller 22 may change the second information or the third information used as the training data in training performed before the trained model 50 is regenerated.

On the other hand, the second controller 22 may perform training using, as the training data, the identical information without changing the second information or the third information used as the training data in the training performed before the trained model 50 is regenerated. In this case, the second controller 22 may change the combination of sets of the preliminary model connected to the model for training and the second information or the third information, from the combination in the training data used in the training performed before the trained model 50 is regenerated. Further, when the second information or the third information is divided into subsets, the second controller 22 may change the combination of the preliminary model connected to the model for training and the subset of the second information or the third information, from the combination in the training data used in the training performed before the trained model 50 is regenerated. The second controller 22 may change the order of pieces of information used as the training data, relative to the order of changing the combination of the model for training and the preliminary model. That is, the second controller 22 may shuffle the order of pieces of information used as the training data. The second controller 22 may regenerate the trained model 50 while changing the information used as the training data or changing the order of pieces of information used as the training data relative to the combination of the model for training and the preliminary model until the recognition accuracy of the trained model 50 becomes equal to or higher than a predetermined accuracy.

When the second controller 22 performs training using the identical information to the training data without changing the second information or the third information, the second controller 22 may change the configuration of the subset of the second information or the third information. That is, the second controller 22 may change the content of the subset and regenerate the trained model 50 while using the identical set of training data.

Note that the method of evaluating and regenerating the trained model 50 may also be applied to training using the first information.

If there is a target for which the trained model 50 generated as the target model has a poor recognition accuracy, the second controller 22 may generate the target model by re-training. In this case, the second controller 22 may perform training based on new training data without using the preliminary models (base models), and thus regenerate the trained model 50 as a new target model. Note that the new training data is also referred to as fourth information. The fourth information may be any information identical to or related to the input information.

### (Configuration Example of Robot Control System 100)

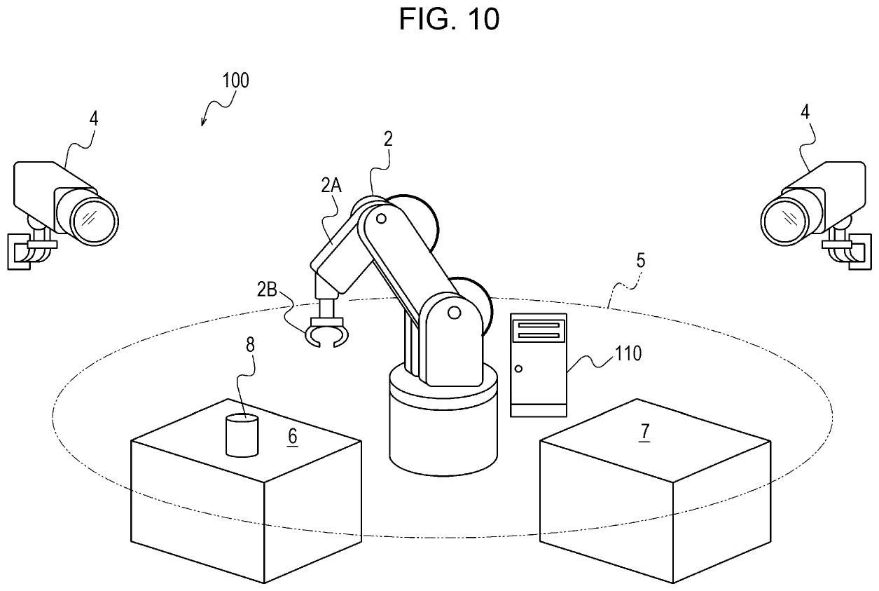

As illustrated in FIG. 10, a robot control system 100 according to one embodiment includes a robot 2 and a robot control apparatus 110. In the present embodiment, the robot 2 moves a workpiece 8 from a work start point 6 to a work destination point 7. That is, the robot control apparatus 110 controls the robot 2 so that the workpiece 8 is moved from the work start point 6 to the work destination point 7. The workpiece 8 is also referred to as a work target. The robot control apparatus 110 controls the robot 2, based on information regarding a space in which the robot 2 performs work. The information regarding the space is also referred to as spatial information.

### <Robot 2>

The robot 2 includes an arm 2A and an end effector 2B. The arm 2A may be, for example, a six-axis or seven-axis vertical articulated robot. The arm 2A may be a three-axis or four-axis horizontal articulated robot or a selective compliance assembly robot arm (SCARA) robot. The arm 2A may be a two-axis or three-axis orthogonal robot. The arm 2A may be a parallel link robot or the like. The number of axes of the arm 2A is not limited to the numbers mentioned as an example. In other words, the robot 2 includes the arm 2A connected by multiple joints, and operates by driving the joints.

The end effector 2B may include, for example, a gripping hand that can grip the workpiece 8. The gripping hand may have multiple fingers. The number of fingers of the gripping hand may be two or more. The fingers of the gripping hand may have one or more joints. The end effector 2B may include a suction hand that can suck the workpiece 8. The end effector 2B may include a scooping hand that can scoop the workpiece 8. The end effector 2B may include a tool such as a drill and may perform various types of machining such as work of drilling a hole in the workpiece 8. The end effector 2B is not limited to these examples, and may perform various other operations. In the configuration illustrated in FIG. 10, the end effector 2B includes a gripping hand.

The robot 2 can control the position of the end effector 2B by operating the arm 2A. The end effector 2B may have an axis serving as a reference of a direction in which the end effector 2B acts on the workpiece 8. When the end effector 2B has an axis, the robot 2 can control the direction of the axis of the end effector 2B by operating the arm 2A. The robot 2 controls the start and end of an operation in which the end effector 2B acts on the workpiece 8. The robot 2 can move or process the workpiece 8 by controlling the operation of the end effector 2B while controlling the position of the end effector 2B or the direction of the axis of the end effector 2B. In the configuration illustrated in FIG. 10, the robot 2 causes the end effector 2B to grip the workpiece 8 at the work start point 6, and causes the end effector 2B to move to the work destination point 7. The robot 2 causes the end effector 2B to release the workpiece 8 at the work destination point 7. In this way, the robot 2 can move the workpiece 8 from the work start point 6 to the work destination point 7.

### <Sensor>

The robot control system 100 further includes a sensor. The sensor detects physical information of the robot 2. The physical information of the robot 2 may include information about an actual position or orientation of each component of the robot 2 or about a velocity or acceleration of each component of the robot 2. The physical information of the robot 2 may include information about a force acting on each component of the robot 2. The physical information of the robot 2 may include information about a current flowing through a motor that drives each component of the robot 2 or about a torque of the motor. The physical information of the robot 2 represents a result of an actual operation of the robot 2. That is, the robot control system 100 can grasp the result of the actual operation of the robot 2 by acquiring the physical information of the robot 2.

The sensor may include a force sensor or a tactile sensor that detects, as the physical information of the robot 2, a force, distributed pressure, slip, or the like acting on the robot 2. The sensor may include a motion sensor that detects, as the physical information of the robot 2, a position, orientation, velocity, or acceleration of the robot 2. The sensor may include a current sensor that detects, as the physical information of the robot 2, a current flowing through the motor that drives the robot 2. The sensor may include a torque sensor that detects, as the physical information of the robot 2, a torque of a motor that drives the robot 2.

The sensor may be installed at a joint of the robot 2 or a joint driving unit that drives the joint. The sensor may be installed also at the arm 2A or the end effector 2B of the robot 2.

The sensor outputs the detected physical information of the robot 2 to the robot control apparatus 110. The sensor detects and outputs the physical information of the robot 2 at a predetermined timing. The sensor outputs the physical information of the robot 2 as time-series data.

### <Cameras 4>

In the configuration example illustrated in FIG. 10, the robot control system 100 includes two cameras 4. The cameras 4 each capture an image of an article, a person, or the like located in an influence range 5 in which the article, the person, or the like may influence the operation of the robot 2. The image captured by the cameras 4 may include monochrome luminance information or luminance information of each color represented by RGB (Red, Green, and Blue) or the like. The influence range 5 includes an operation range of the robot 2. The influence range 5 is a range obtained by further expanding the operation range of the robot 2 outward. The influence range 5 may be set such that the robot 2 can be stopped before a person or the like who moves from the outside of the operation range of the robot 2 toward the inside of the operation range enters the inside of the operation range of the robot 2. The influence range 5 may be set to, for example, a range expanded outward from a boundary of the operation range of the robot 2 by a predetermined distance. The cameras 4 may be installed so that the cameras 4 can capture an overview image of the influence range 5 or operation range of the robot 2 or a region in the vicinity of the influence range 5 or operation range. The number of cameras 4 is not limited to two, and may be one or may be three or more.

### <Robot Control Apparatus 110>

The robot control apparatus 110 acquires the trained model 50 generated by the trained model generation apparatus 20. Based on the images captured by the cameras 4 and the trained model 50, the robot control apparatus 110 recognizes the workpiece 8, the work start point 6, the work destination point 7, or the like present in a space where the robot 2 performs the work. In other words, the robot control apparatus 110 acquires the trained model 50 that is generated to recognize the workpiece 8 or the like based on the images captured by the cameras 4. The robot control apparatus 110 is also referred to as an inference apparatus.

To provide control and processing capabilities for performing various functions, the robot control apparatus 110 may include at least one processor. Each component of the robot control apparatus 110 may include at least one processor. Multiple components among the components of the robot control apparatus 110 may be implemented by one processor. The entire robot control apparatus 110 may be implemented by one processor. The processor can execute a program for implementing various functions of the robot control apparatus 110. The processor may be implemented as a single integrated circuit. The integrated circuit is also referred to as an IC. The processor may be implemented as multiple integrated circuits and discrete circuits connected to be able to perform communication. The processor may be implemented based on various other known technologies.

The robot control apparatus 110 may include a storage. The storage may include an electromagnetic storage medium such as a magnetic disk, or may include a memory such as a semiconductor memory or a magnetic memory. The storage stores various kinds of information and a program or the like to be executed by the robot control apparatus 110. The storage may be a non-transitory readable medium. The storage may function as a work memory of the robot control apparatus 110. At least a part of the storage may be a separate device from the robot control apparatus 110.

### (Operation Example of Robot Control System 100)

The robot control apparatus 110 (inference apparatus) acquires the trained model 50 in advance. The robot control apparatus 110 may store the trained model 50 in the storage. The robot control apparatus 110 acquires captured images of the workpiece 8 from the cameras 4. The robot control apparatus 110 inputs, as input information, the captured images of the workpiece 8 to the trained model 50. The robot control apparatus 110 acquires output information output from the trained model 50 in response to the input of the input information. The robot control apparatus 110 recognizes the workpiece 8 based on the output information, and performs work of gripping or moving the workpiece 8.

### BRIEF SUMMARY

As described above, the robot control system 100 can acquire the trained model 50 from the trained model generation system 1, and recognize the workpiece 8 with the trained model 50.

### (Use Cases in Component Recognition Model)

An example of use cases of the trained model generation system 1 according to the present embodiment is described.

An actor may be an administrator of the trained model generation apparatus 20, a user who introduces the robot 2, or the robot control apparatus 110. A system used by the actor may be the trained model generation system 1 or the robot control system 100 that performs a pick-and-place task. The use case of each actor is exemplified below. The administrator of the trained model generation apparatus 20 generates a general-purpose model. The user who introduces the robot 2 creates a dedicated model or registers recognition target components. The user who introduces the robot 2 causes the robot 2 to perform the pick-and-place task. The robot control apparatus 110 acquires the trained model 50.

### <Use Pattern A>

As a use pattern A, a case is assumed where the user who introduces the robot 2 requests the robot control system 100 to recognize components in a large classification such as screws or nuts if the recognition targets does not include a component unique to the user or even if the recognition targets include a component unique to the user.

In this case, the user may use the general-purpose model without performing new training. Therefore, the administrator of the trained model generation apparatus 20 generates the trained model 50 which is a general-purpose model. In this case, the trained model generation apparatus 20 generates the trained model 50 using, as the second information, information identical to the first information used to generate the preliminary models.

### <Use Pattern B>

As a use pattern B, a case is assumed where the user who introduces the robot 2 requests the robot control system 100 to recognize a component unique to the user.

In this case, the second information or the third information serving as the training data for recognizing the component unique to the user is needed. The administrator of the trained model generation apparatus 20 performs training using, as the training data, the second information or the third information for recognizing the component unique to the user, and thus generates the trained model 50 which is a dedicated model. When the head alone is generated as a dedicated model, the trained model generation apparatus 20 may generate the backbone as a general-purpose model or as a dedicated model.

### (About Division Unit of Trained Model 50)

In the trained model generation system 1 described above, the trained model 50 is generated by being divided into two models which are the first trained model 51 and the second trained model 52. The division number is not limited to two, and the trained model 50 may be divided into three or more models. For example, when the trained model 50 has multiple layers, the trained model 50 may be divided into models for the respective layers. The trained model generation system 1 may train a model in which each of the divided models is connected to multiple preliminary models, and thus generate the trained model 50 corresponding to each of the divided models.

For example, when the trained model 50 is divided into three models of a first model, an intermediate model, and a last model, the trained model generation apparatus 20 may set the intermediate model as a training-underway model, connect portions of the preliminary models corresponding to the first and last models to the intermediate model, and perform training.

In the trained model 50, the second yet-to-be-trained model (head) may be divided into two or more portions. In this case, the second controller 22 of the trained model generation apparatus 20 may fix at least one portion of the two or more portions obtained by dividing the second yet-to-be-trained model (head). The second controller 22 may train a model in which the head, in which the fixed portion of the second yet-to-be-trained model and the portion of the preliminary model corresponding to the other portion of the second yet-to-be-trained model are connected to each other, and the backbone of the preliminary model are connected to each other.

In the trained model 50, the first yet-to-be-trained model (backbone) may be divided into two or more portions. In this case, the second controller 22 may fix at least one portion of the two or more portions obtained by dividing the first yet-to-be-trained model (backbone). The second controller 22 may train a model in which the backbone, in which the fixed portion of the first yet-to-be-trained model and the portion of the preliminary model corresponding to the other portion of the first yet-to-be-trained model are connected to each other, and the head of the preliminary model are connected to each other.

The other portion of the head and the backbone, which are sequentially connected to the fixed portion of the head, or the other portion of the backbone and the head, which are sequentially connected to the fixed portion of the backbone may be a set created in one preliminary model.

When a portion of the head is fixed, the portion of the head may correspond to lower-dimension processing than the other portion of the head that is not fixed. When a portion of the backbone is fixed, the portion of the backbone may correspond to lower-dimensional processing than the other portion of the backbone that is not fixed. In other words, a portion of the head or the backbone corresponding to the low-dimensional processing may be fixed. For example, in a model having CNN layers, a portion corresponding to the upstream of the CNN layers may be fixed.

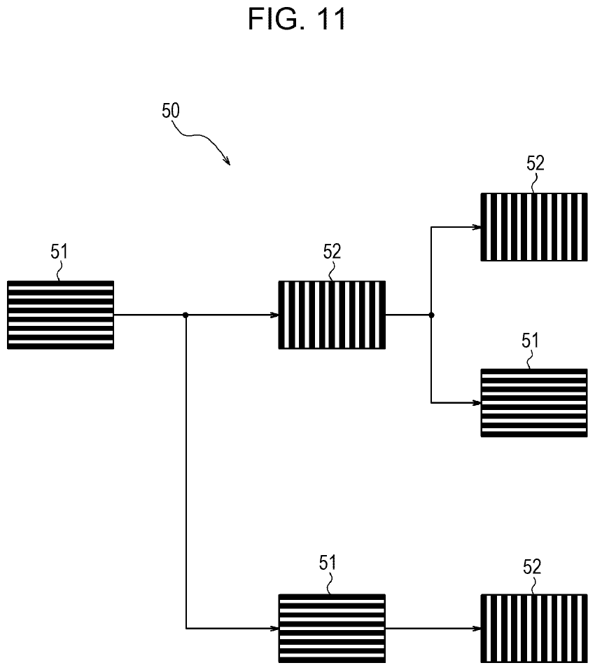

The trained model 50 may include a branch model as illustrated in FIG. 11. The branch model means a model in which an output from a layer branches and is input to two or more next layers. In the trained model 50, the first trained model 51 and the second trained model 52 may be connected in various combinations. In the branch model, a model corresponding to the first portion and a model corresponding to the second portion may be connected in various combinations. The branch model may be, for example, a region proposal network (RPN).

(Changing Base Model in Accordance with Yet-To-Be-Trained Model)

As described above, the second controller 22 of the trained model generation apparatus 20 performs training based on the second information with the base model corresponding to the first portion of the model and the yet-to-be-trained model (the second yet-to-be-trained model 520) corresponding to the second portion of the model being connected to each other. In this training, the second controller 22 may change not only the yet-to-be-trained model corresponding to the second portion of the model but also the base model corresponding to the first portion of the model in accordance with the change of the yet-to-be-trained model. In other words, when performing training with the base model and the target model being connected to each other, the second controller 22 may change various parameters in the base model set by preliminary training. As a result, for example, even when training processing is performed by connecting a base model subjected to different training processing to a target model, the influence of the domain gap can be reduced and the inference accuracy of the trained model 50 can be increased. The domain gap is a phenomenon caused by a difference between a training environment and an inference environment. That is, even for the identical subject, a domain gap may occur because of a difference between an acquisition environment of images used as the training data and an acquisition environment of images used as inference data. Therefore, to reduce the influence of the domain gap, fine tuning may need to be performed based on images acquired in the inference environment (the robot use environment). In other words, to reduce the influence of the domain gap, the target model may need to be re-trained based on images obtained in the robot use environment. That is, when the target model includes a portion of the base model, by changing the parameters of the base model included in the target model by training based on the images obtained in the robot use environment, the influence of the domain gap can be reduced.

(Model in which First Portion or Second Portion Is Divided into Multiple Portions)

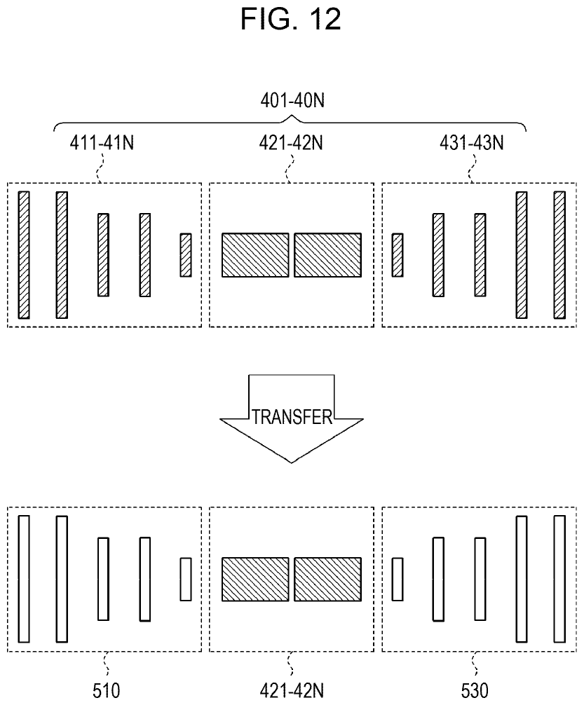

At least one of the first portion or the second portion of the model may be divided into multiple portions. For example, as illustrated in FIG. 12, each of the trained preliminary models 401 to 40N may include the first trained preliminary models 411 to 41N, the second trained preliminary models 421 to 42N, and third trained preliminary models 431 to 43N. In the example of FIG. 12, the second trained preliminary models 421 to 42N correspond to the first portion of the model. The first trained preliminary models 411 to 41N and the third trained preliminary models 431 to 43N correspond to the second portion of the model.

The second controller 22 of the trained model generation apparatus 20 may sequentially transfer each of the second trained preliminary models 421 to 42N corresponding to the first portion of the model, and train a model in which the transferred one of the second trained preliminary models 421 to 42N is connected between the first yet-to-be-trained model 510 and a third yet-to-be-trained model 530 that correspond to the second portion of the model.

In the example of FIG. 12, a portion connected to the input side (left side) of the two divided second portions is also referred to as an encoder. A portion connected to the output side (right side) of the two divided second portions is also referred to as a decoder.

Not only the second portion is divided into multiple portions as illustrated in FIG. 12 but also the first portion may be divided into multiple portions. When the first portion is divided into multiple portions, the second portion connected between the multiple first portions may be trained.

### (Operation Example of Generating Both or One of Backbone and Head)

In the embodiment described in the first half of the present disclosure, in the trained model generation system 1, the head of the trained model 50 can be generated by training a model in which the backbone of the preliminary model is connected to the head for training. On the other hand, in the trained model generation system 1, the backbone of the trained model 50 may be generated by training a model in which the head of the preliminary model is connected to the backbone for training. Note that the head or the backbone of the trained model 50 alone may be used.

When the backbone of the trained model 50 is generated, for example, the backbone may be generated in the following manner. Specifically, as illustrated in FIG. 5, the first controller 12 of the preliminary model generation apparatus 10 generates or acquires the multiple yet-to-be-trained preliminary models 301 to 30N in advance. In FIG. 5, the layer configuration of the fully-connected layer or the parameter size of each layer in the second yet-to-be-trained preliminary model 321 and the layer configuration of the fully-connected layer or the parameter size of each layer in the second yet-to-be-trained preliminary model 32N are different from each other. That is, the layer configurations of the fully-connected layers or the parameter sizes of the respective layers in the second yet-to-be-trained preliminary models 321 to 32N are different from each other. In FIG. 5, the layer configuration of the CNN or the filter size of each layer in the first yet-to-be-trained preliminary model 311 is identical to the layer configuration of the CNN or the filter size of each layer in the first yet-to-be-trained preliminary model 31N. That is, the layer configurations of the CNNs or the filter sizes of the respective layers in the first yet-to-be-trained preliminary models 311 to 31N are identical. The layer configurations of the CNNs or the filter sizes of the respective layers in the first yet-to-be-trained preliminary models 311 to 31N may be different from each other.

The first controller 12 trains each yet-to-be-trained preliminary model 30 using, as training data, the first information identical to or related to input information to be input to the trained model 50. The first controller 12 updates the yet-to-be-trained preliminary models 30 by training and generates the multiple trained preliminary models 401 to 40N. The layer configurations of the fully-connected layers or CNNs or the parameter sizes or filter sizes of layers in the trained preliminary models 40 are identical to the layer configurations of the fully-connected layers or CNNs or the parameter sizes or filter sizes of layers in the respective yet-to-be-trained preliminary models 30.

The second controller 22 of the trained model generation apparatus 20 acquires the trained preliminary models 40 as preliminary models from the preliminary model generation apparatus 10. The second controller 22 trains a model in which the head of each preliminary model is connected to the backbone for training using, as training data, third information identical to or related to input information to be input to the trained model 50. The head of each preliminary model corresponds to the first portion of the base model. The backbone for training corresponds to the second portion of the target model. The third information may be identical to or different from the first information or the second information. The third information may include multiple training images as one set. The second controller 22 may train models in which the head of the respective preliminary models is connected to the backbone for training using, as training data, the identical set of the third information or may train the models using, as training data, different sets of the third information. The second controller 22 may divide one set of the third information into smaller subsets, and perform training using a different subset as the training data each time the head connected to the backbone for training is changed. The second controller 22 may perform training using, as the training data, the identical subset when the head connected to the backbone for training is changed. That is, the second controller 22 may train a model in which the head of each preliminary model is connected to the backbone for training, based on at least one set of the third information. Note that an information amount of the third information used in training for the trained model 50 may be equal to or less than an information amount of the first information used for training of the preliminary models. Note that the information amount refers to, for example, the number of training images included in the third information.

Specifically, as illustrated in FIG. 6, the second controller 22 sequentially train a model in which the head (the second trained preliminary models 421 to 42N) of each of the preliminary models is transferred and connected to the first yet-to-be-trained model 510 or a respective one of the first training-underway models 511 to 51(N−1). The second controller 22 may perform training in a procedure below. The second controller 22 trains a model in which the second trained preliminary model 421 is connected to the first yet-to-be-trained model 510 to update the first yet-to-be-trained model 510 to the first training-underway model 511. The second controller 22 trains a model in which the second trained preliminary model 422 is connected to the first training-underway model 511, which is obtained by the update in the previous step, to update the first training-underway model 511 to the first training-underway model 512. The second controller 22 trains a model in which the second trained preliminary model 42N is connected to the first training-underway model 51(N−1), which is obtained by the update in the previous step, to update the first training-underway model 51(N−1) to the first trained model 51N.

The second controller 22 executes the procedure described above to generate the first trained model 51N. The second controller 22 employs the first trained model 51N as the first trained model 51 (the backbone of the trained model 50). The first trained model 51N generated by training with being connected to the first portion of the base model corresponds to the second portion of the target model.

As described above, in the trained model generation system 1, both or one of the backbone and the head can be generated based on training of a model to which the corresponding head or backbone is connected.

Note that the relationship between the first portion and the second portion of the model including the backbone generated based on training in which the multiple heads are connected is opposite to the relationship between the first portion and the second portion of the model including the head generated based on training in which the multiple backbones are connected in the embodiment described in the first half of the present disclosure. Specifically, the above can be read as in generation of the backbone based on the training in which the multiple heads are connected, training is performed by connecting the first portion of each of the multiple preliminary models to the second portion of the target model. Conversely, in the generation of the backbone based on training in which the multiple backbones are connected, as in the embodiment described in the first half of the present disclosure, it can also be read that training is performed by connecting the second portion of each of the multiple preliminary models to the first portion of the target model. That is, the first portion and the second portion of the model may be interchanged as appropriate. In the trained model generation system 1, both or one of the first portion and the second portion of the model can be generated based on training of a model to which the corresponding second portion or first portion is connected.

### (Loss Function)

The trained model generation system 1 may set a loss function such that the output obtained in response to input of the input information to the generated trained model 50 approaches the output obtained in response to input of the training data. In the present embodiment, cross-entropy may be used as the loss function. The cross-entropy is calculated as a value representing a relationship between two probability distributions. Specifically, in the present embodiment, the cross entropy is calculated as a value representing the relationship between the input information and the backbone or head.

The trained model generation system 1 performs training such that the value of the loss function decreases. In the trained model 50 generated by performing training such that the value of the loss function decreases, the output corresponding to the input of the input information can approach the output corresponding to the input of the training data. The loss function to be used may be, for example, a discrimination loss or contrastive loss. The discrimination loss is a loss function used to perform training by labeling the authenticity of a generated image with a numerical value in a range from 1, which represents completely true, to 0, which represents completely false.

Although the embodiments of the trained model generation system 1 and the robot control system 100 have been described above, the embodiments of the present disclosure may be implemented as a method or a program for implementing the system or the apparatus, or a storage medium (for example, an optical disk, a magneto-optical disk, a compact disc read-only memory (CD-ROM), a compact disc recordable (CD-R), a compact disc rewritable (CD-RW), a magnetic tape, a hard disk, or a memory card) in which the program is recorded.

The implementation of the program is not limited to an application program such as object code compiled by a compiler or program code executed by an interpreter, and can also take any form such as a program module or the like incorporated into an operating system. Furthermore, the program may or may not be configured so that all processing is performed only in a CPU on a control board. The program may be configured to be executed entirely or partially by another processing unit mounted on an expansion board or expansion unit added to the board as necessary.

While the embodiments of the present disclosure have been described based on the various drawings and the examples, it is to be noted that a person skilled in the art can make various variations or corrections based on the present disclosure. Therefore, it is to be noted that these variations or corrections are within the scope of the present disclosure. For example, the functions and the like included in the components and the like can be rearranged so as not to be logically inconsistent, and multiple components and the like can be combined into one or divided.

All of the constituent elements described in the present disclosure and/or all of the disclosed methods or all of the steps of disclosed processing can be combined in any combination, except for combinations in which features thereof are mutually exclusive. Each of the features described in the present disclosure can be replaced by alternative features that serve for the same, equivalent, or similar purposes, unless explicitly stated otherwise. Therefore, unless explicitly stated otherwise, each of the disclosed features is merely one example of a comprehensive set of identical or equivalent features.

Further, the embodiments according to the present disclosure are not limited to any of the specific configurations of the embodiments described above. The embodiments according to the present disclosure can be extended to all novel features, or combinations thereof, described in the present disclosure, or all novel methods, or processing steps, or combinations thereof, described in the present disclosure.

In the present disclosure, “first”, “second,” and so on are identifiers used to distinguish between the components. In the present disclosure, the components distinguished by “first”, “second”, and so on may exchange the numerals of the components. For example, “first” which is the identifier of the first information may be exchanged with “second” which is the identifier of the second information. The exchange of the identifiers is performed simultaneously. Even after the exchange of the identifiers, the components are distinguished from each other. The identifiers may be deleted. The components whose identifiers are deleted are distinguished from each other by reference signs. The identifiers such as “first” and “second” in the present disclosure are not to be used as a basis for the interpretation of the order of the components and the existence of the identifier with a smaller number.

### REFERENCE SIGNS

1 trained model generation system
10 preliminary model generation apparatus (12: first controller)
20 trained model generation apparatus (22: second controller)
30 (301 to 30N) yet-to-be-trained preliminary model (31 (311 to 31N): first yet-to-be-trained preliminary model, 32 (321 to 32N): second yet-to-be-trained preliminary model)
40 (401 to 40N) trained preliminary model (41 (411 to 41N): first trained preliminary model, 42 (421 to 42N): second trained preliminary model, 431 to 43N: third trained preliminary model)
50 trained model (51: first trained model, 52: second trained model, 510: first yet-to-be-trained model, 520: second yet-to-be-trained model)
100 robot control system (2: robot, 2A: arm, 2B: end effector, 4: camera, 5: influence range of robot, 6: work start point, 7: work destination point, 8: workpiece, 110: robot control apparatus (inference apparatus)

1. A trained model generation method comprising:
generating a trained model that outputs a recognition result of a recognition target included in input information, based on multiple models each including at least one of a first portion or a second portion, wherein
the generating of the trained model comprises,
acquiring multiple base models each including a portion corresponding to the first portion, the multiple base models being trained based on at least one set of first information related to the input information,
acquiring multiple target models each including a portion corresponding to the second portion, each of the multiple target models being trained based on at least one set of second information related to the input information with being connected to a respective base model of the multiple base models, and
generating the trained model at least including, among the multiple target models, a target model including the portion corresponding to the second portion.

2. The trained model generation method according to claim 1, wherein the second information is information identical to the first information.

3. The trained model generation method according to claim 1, wherein the second information is information different from the first information.

4. The trained model generation method according to claim 1, further comprising:
generating, as the trained model, a model in which a target model corresponding to the first portion and trained based on third information related to the input information is connected to a target model corresponding to the second portion.

5. The trained model generation method according to claim 4, wherein the third information is information identical to the first information.

6. The trained model generation method according to claim 4, wherein the third information is information different from the first information.

7. The trained model generation method according to claim 1, wherein
the first portion of the model corresponds to a backbone that extracts a feature quantity of the recognition target, and
the second portion of the model corresponds to a head that outputs the recognition result based on an extraction result of the feature quantity.

8. The trained model generation method according to claim 1, wherein
the first portion of the model corresponds to a head that outputs the recognition result based on an extraction result of a feature quantity of the recognition target, and
the second portion of the model corresponds to a backbone that extracts the feature quantity.

9. The trained model generation method according to claim 1, wherein the trained model includes a branch model.

10. The trained model generation method according to claim 1, further comprising:
performing training based on the second information with a base model corresponding to the first portion of the model and a yet-to-be-trained model corresponding to the second portion of the model being connected to each other to change the base model in accordance with the yet-to-be-trained model and generate a model in which the yet-to-be-trained model is changed as the target model.

11. The trained model generation method according to claim 1, wherein at least one base model among the multiple base models has a different model configuration from other base models among the multiple base models.

12. The trained model generation method according to claim 1, wherein in the generating of the trained model, the multiple base models are generated by performing training using an identical set of the first information.

13. The trained model generation method according to claim 1, wherein
each of the multiple models further includes a third portion, and
the generating of the trained model further comprises,
acquiring multiple target models each including a portion corresponding to the second portion and a portion corresponding to the third portion, each of the multiple target models being trained based on at least one set of second information related to the input information with being connected to a respective base model of the multiple base models, and
generating a trained model at least including, among the multiple target models, a target model including the portion corresponding to the second portion and the portion corresponding to the third portion.

14. An inference apparatus comprising:
a trained model generated based on multiple models each including at least one of a first portion or a second portion, the trained model being configured to output a recognition result of a recognition target included in input information, wherein
the trained model at least includes target models each including a portion corresponding to the second portion and being obtained by performing training based on at least one set of second information related to the input information with being connected to a respective base model of multiple base models, each of the multiple base models including a portion corresponding to the first portion and being trained based on at least one set of first information related to the input information.

15. A trained model generation apparatus comprising:
a controller configured to generate a trained model that outputs a recognition result of a recognition target included in input information, based on multiple models each including at least one of a first portion or a second portion, wherein
in the generating of the trained model, the controller is configured to:
acquire multiple base models each including a portion corresponding to the first portion, the multiple base models being trained based on at least one set of first information related to the input information;
acquire multiple target models each including a portion corresponding to the second portion, each of the multiple target models being trained based on at least one set of second information related to the input information with being connected to a respective base model of the multiple base models; and
generate the trained model at least including, among the multiple target models,
